(19) United States
(12) Patent Application Publication
(10) Pub. No.: US 2005/0115641 A1
(43) Pub. Date: Jun. 2, 2005

(54) Weaving horse assembly

(76) Inventors: Barbara M. Fox, Atwater, OH (US); John McCurdy, Nashport, OH (US); Christopher J. Holland, Nashport, OH (US); Debbie S. Ianniello, West Lafayette, OH (US); Mark D. Weaver, Nashport, OH (US); Shannon D. Casey, Adamsville, OH (US); Deanna J. Brown, Crooksville, OH (US); Kennon E. Scott, Conesville, OH (US); James A. Harney JR., Roseville, OH (US); Dana R. Ayres, Nashport, OH (US); Robert C. Beach, Adamsville, OH (US); Timothy Reed, Zanesville, OH (US); Charles Mauro, New York, NY (US); Lester Miller, New York, NY (US); Fred Williams, Newark, OH (US)

Correspondence Address: Charma Murphy;Porter, Wright, Morris & Arthur LLP, Intellectual Property -- Docketing, 41 South High Street, 28th Floor, Columbus, OH, 43215-6194, US

(21) Appl. No.: 10/829,663

(22) Filed: Apr. 22, 2004

Related U.S. Application Data
(60) Provisional application No. 60/464,379, filed on Apr. 22, 2003.

(51) Int. Cl. B27J 1/00

(52) U.S. Cl. 147/48

(57) ABSTRACT

A weaving horse assembly for supporting a basket form during construction of a woven basket. The weaving horse assembly comprises a support structure and a clamp arm including a U-shaped frame. The base of the U-shaped frame is rotatably mounted to the support structure such that the clamp arm is movable from a generally vertical position to a generally horizontal position. The U-shaped frame has upper and lower arms each having a free end, with the free end of the lower arm defining a form pole for supporting a basket form and the free end of the upper arm defining a clamp for securing a basket bottom to the basket form.

### CROSS-REFERENCE TO RELATED APPLICATIONS

This application claims the benefit of U.S. provisional patent application No. 60/464,379, filed Apr. 22, 2003, the content of which is incorporated herein by reference.

### STATEMENT REGARDING FEDERALLY SPONSORED RESEARCH

Not applicable

### REFERENCE TO MICROFICHE APPENDIX

Not applicable

### FIELD OF THE INVENTION

The present invention generally relates to an apparatus for basket construction, and more particularly, to a weaving horse for supporting a basket form or mold during construction of a woven basket.

### BACKGROUND OF THE INVENTION

Woven wooden baskets generally are made by shaping thin flexible wood strips or splints around the outside of a basket form or mold. The bottom and sides of the form are sized and shaped to correspond to the desired size and shape of a basket interior.

During weaving, the form typically is supported on a weaving stand or “horse.” Conventional weaving horses support the basket form in either a generally upright position or a generally horizontal position to allow the weaver to vary the position of the form depending on the characteristics of a particular basket or the weaver's preferences. The weaver must manually shift the horse from one position to the other, commonly referred to as “flipping the horse.” Basket forms typically are made of wood, so repeated flipping of the horse may be tiring, especially when making baskets that require a large, heavy form.

Conventional weaving horses have no height adjustment. The same weaving position must be used regardless of the size of the weaver or the characteristics of the basket. The lack of a height adjustment results in poor sight lines, making it difficult for a weaver to monitor the work in progress. Conventional horses also require weaving in a standing position.

Conventional weaving horses allow rotation of the form during weaving so that the weaver can have easy access to all sides of the basket. Because the form is permitted to rotate freely, a weaver must exert pressure against the form to prevent unwanted rotation during weaving.

The repetitive nature of basket weaving activities and the ergonomically unfavorable body positions often observed with conventional weaving horses may result in fatigue, discomfort, dissatisfied weavers, or even injuries. The physical demands of weaving using conventional weaving horses also make it more difficult for new weavers to learn their craft.

Consumers hold hand-woven wooden baskets in high regard because of their unique character. Subtle irregularities and slight variations from basket to basket are acceptable to consumers, but not loose, uneven weaving or misshapen baskets. The physical demands of weaving using conventional weaving horses may result in baskets that are of inferior quality as well as loss of production efficiency.

### SUMMARY OF THE INVENTION

It is an object of the invention to provide a support structure for constructing articles such as baskets that require access to all sides of the article.

It is another object of the invention to provide a weaving horse assembly to produce high quality baskets more efficiently.

It is yet another object of the invention to provide a weaving horse assembly that allows better ergonomic position of a weaver relative to the basket being constructed.

The foregoing objectives are achieved in a weaving horse assembly, comprising a support structure and a clamp arm comprising a U-shaped frame. The base of the U-shaped frame is rotatably mounted to the support structure such that the clamp arm is movable from a generally vertical position to a generally horizontal position. The U-shaped frame includes upper and lower arms each having a free end. The free end of the lower arm defines a form pole for supporting a basket form and the free end of the upper arm defines a clamp for securing a basket bottom to the basket form.

The support structure may comprise a vertical support member and a carriage slidably mounted on the vertical support member. The base of the U-shaped member may be mounted to the carriage such that the movement of the carriage relative to the vertical support member adjusts the height of the clamp arm. The weaving horse assembly may include means for moving the carriage relative to the vertical support member.

The weaving horse assembly also may comprise a ratchet assembly mounted on the free end of the lower arm. The ratchet assembly cooperates with the form pole such that an operator can select a basket form rotational state from a group consisting of clockwise rotation, counterclockwise rotation, and no rotation. The weaving horse assembly may include a switch connected to the ratchet assembly such that the switch controls the rotational state of the basket form.

The upper arm of the weaving horse assembly may include a tubular outer arm that terminates at a distance spaced laterally from the form pole and an inner arm slidably receivable within the outer arm, such that the length of the upper arm may be adjusted. The clamp on the free end of the upper arm may comprise a push rod assembly. The weaving horse assembly also may include means for altering the pressure exerted by the push rod assembly against a basket bottom.

### BRIEF DESCRIPTION OF THE DRAWINGS

These and further features of the present invention will be apparent with reference to the following description and drawings, wherein:

FIG. 1A is a schematic view of a conventional weaving horse showing the relationship between the horse and the body of atypical weaver.

FIG. 1B is a schematic view of the weaving horse assembly of the present invention showing the relationship between the horse assembly and the body of a typical weaver in a standing position.

FIG. 1C is a schematic view of the weaving horse assembly of the present invention showing the relationship between the horse assembly and the body of a typical weaver in a seated position.

FIG. 2 is a perspective view of an embodiment of the weaving horse assembly and material wall of the present invention, the material wall including a plurality of open-ended semi-cylindrical shelves removably mounted on a rack.

FIG. 3 is a perspective view of an embodiment of the forming table of the present invention, including a removable clamping unit with adjustable splint stops and a hinged splint clamp slidably mounted on a rod that extends across the rear portion of the clamping unit.

FIG. 4 is a front schematic view of another embodiment of the weaving horse assembly of the present invention.

FIG. 5 is a side schematic view of the weaving horse assembly of FIG. 4.

FIG. 6 is a side schematic view of the vertical support member of the weaving horse assembly of FIG. 4.

FIG. 7 is a front schematic view of the carriage assembly of the weaving horse assembly of FIG. 4.

FIG. 8 is a front schematic view of the carriage assembly of the weaving horse assembly of FIG. 4.

FIG. 9 is a side schematic view of the carriage assembly of the weaving horse assembly of FIG. 4.

FIG. 10 is a front schematic view of the ratchet assembly of the weaving horse of FIG. 4.

FIG. 11 is a side schematic view of the ratchet assembly of the weaving horse of FIG. 4.

FIG. 12 is a front schematic view of the extension assembly of the weaving horse of FIG. 4.

FIG. 13 is a top schematic view of the extension assembly of the weaving horse of FIG. 4.

FIG. 14 is a side schematic view of the push rod assembly of the weaving horse of FIG. 4.

FIG. 15 is a front schematic view of the clamp arm assembly of the weaving horse of FIG. 4.

FIG. 16 is a rear schematic view of the clamp arm assembly of the weaving horse of FIG. 4.

FIG. 17 is a top schematic view of the clamp arm assembly of the weaving horse of FIG. 4.

FIG. 18 is a free end schematic view of the clamp arm assembly of the weaving horse of FIG. 4.

FIG. 19 is a base end schematic view of the clamp arm assembly of the weaving horse of FIG. 4.

It should be understood that the appended drawings are not necessarily to scale and present somewhat simplified representation of various preferred features illustrative of the basic principles of the invention. The specific design features of the weaving horse assembly as disclosed herein, including, for example, specific dimensions, orientations, and connectors, will be determined in part by the particular intended application and use environment. Certain features of the illustrated embodiments have been enlarged or distorted relative to others to facilitate visualization and clear understanding. All references to direction and position, unless otherwise indicated, refer to the orientation of the weaving horse assembly illustrated in the drawings. In general, up or upward refers to an upward direction in the plane of the paper in FIG. 4 and down or downward refers to a downward direction in the plane of the paper in FIG. 4.

### DETAILED DESCRIPTION OF CERTAIN PREFERRED EMBODIMENTS

The invention comprises an integrated work station including a support for a work piece that requires rotation to permit operator access to all sides of the work piece. The following detailed discussion of various alternative and preferred embodiments will illustrate the general principles of the invention with respect to an embodiment of the invention useful in weaving baskets. It will be apparent to those skilled in the art, that is, to those who have knowledge or experience in this area of technology, that many uses and design variations are possible for the support assembly disclosed herein.

The invention comprises an integrated work station including a weaving horse assembly, an adjustable height forming table, and a material storage wall. The weaving horse assembly is a support structure for constructing articles such as baskets that require access to all sides of the article. The assembly provides a high number of power-assisted and manual adjustments to adjust to work position based on a user's body size, position (standing or seated), the nature of the work piece, and personal preferences.

Wooden baskets typically include splints, which define the vertical structure of the basket, and weave strips, which define the horizontal structure of the basket. Generally, the splints extend continuously from the top of one side of the basket, across the basket bottom, to the top of the opposing side of the basket. The weave strips extend circumferentially around the basket in a generally horizontal direction and are woven through the splints in a conventional alternating over-and-under or another weave pattern. Successive rows of weave strips are added at predetermined distances from each other until the basket reaches a desired height. Two or more thicknesses of splints or strips may be layered together to strengthen the finished basket.

Certain baskets, and particularly certain round baskets, are made by forming the basket bottom panel directly on the horse at the beginning of the weaving step. For a round basket, weaving splints are selected that are at least twice the desired height of the basket side panels plus the diameter of the basket. The desired number of splints is placed in overlapping relationship at the bottom center of the basket with their ends angularly offset from one another. The array of splints would be secured together in this position, for example, by a tack placed through the splint centers.

Other baskets, and particularly certain rectangular baskets, are made using a two-step process in which the basket bottom panel is formed separately from the side panels. The bottom panel is first constructed during the “forming” step and the basket sides are then constructed, with the aid of a basket form, during the weaving step.

In the forming step for a rectangular basket, weaving splints that are at least twice the desired height of the basket side panels plus the length or width of the basket, depending upon the intended orientation of the splint relative to the basket bottom. Certain weaving splints, referred to as cross splints, are arranged in parallel relationship to one another on a forming table or other flat surface. Each cross splint is transversely spaced from an adjacent splint, although the spacing may vary with the basket design. Fill splints may be inserted between the cross splints, if desired, to aid in the spacing of the cross splints and to provide a more solid basket bottom by reducing the size of the gaps that otherwise would be present between the cross splints in the bottom panel. The fill splints do not extend beyond the edges of the basket bottom and do not form any part of the vertical structure of the side panels of the basket. The forming table may be provided with markings or raised guides, or a combination of these, to aid in positioning the splints. The guides may be adjustable to accommodate splints for baskets of different sizes. Other weaving splints, referred to as up splints, are oriented perpendicularly to the cross splints. As with the cross splints, the up splints are generally arranged in spaced parallel relationship with one another, although the spacing may vary with the basket design. The up splints are woven through the cross splints in a desired pattern. An alternating over-and-under pattern commonly is used, although other weave patterns also may produce satisfactory results. A weight generally is used with conventional forming tables to retain an end of the cross splints in position while weaving in the up splints.

Formed basket bottoms having more than four sides also may be formed, with the additional splints groups being provided such that the total number of groups is one-half the number of sides. The splint groups are arranged relative to one another at an angle determined by dividing 180 degrees by the number of splint groups. For example, the splint groups in a hexagonal bottom basket would be arranged relative to one another at an angle of 60 degrees.

The forming of a basket bottom continues until the centers of the splints form a woven center of a desired size, with unwoven splint ends projecting outwardly from all sides of the center. The woven center will form the bottom of the basket and the unwoven splint ends will form the vertical structure of the basket sides. Reinforcements may be incorporated into the woven center as is well known in the art. The weaving splints (and any reinforcements used) usually are secured together when the woven center has reached its desired size to prevent disturbance of the arrangement of the splints during transfer of the bottom panel to a basket form and positioning of the bottom panel on the form. This commonly is accomplished using fasteners such as tacks, although other suitable methods of securing the bottom panel components also may be used. After the bottom panel components have been secured in position, the basket bottom may be lifted from the work surface.

Construction of the basket sides begins may begin when the preformed bottom or circular splint array is placed on the bottom of a basket form. The basket form assists the weaver in shaping the splints, in weaving the generally horizontally disposed weave strips there between, and in affixing a rim, reinforcing members, handle and/or other accessories to the upper open end of the basket wall or body. The basket form is supported on a weaving horse in an inverted position to facilitate the proper positioning of the preformed bottom panel or splint array on the bottom of the form. The top of the form defines a recess for receiving a spindle extending from the horse. The basket bottom or splint array is clamped to the bottom of the form to maintain the bottom or array in position when the form is manipulated during weaving.

The basket sides are constructed by weaving strips through the splints, usually beginning next to the woven center of the bottom panel or the center of the splint array and working toward the free ends of the up splints, using the form to guide the shape of the basket sides. The weave strips are drawn tight against the form such that the weave splints remain in close conformance to the form sides until weaving is completed. When the basket side panels have reached the desired height, the ends of the weave splints are trimmed and secured to a top band. After the basket is completed, it is removed from the form.

Circular baskets made without preformed bottoms typically have rows of closely spaced narrow “shoestring” weave adjacent to the center of the circular splint array. These rows of shoestring weave must be drawn tight to maintain the shape and structural integrity of the basket. Many weavers regard circular baskets with shoestring weaving to be among the more difficult baskets to make for this reason.

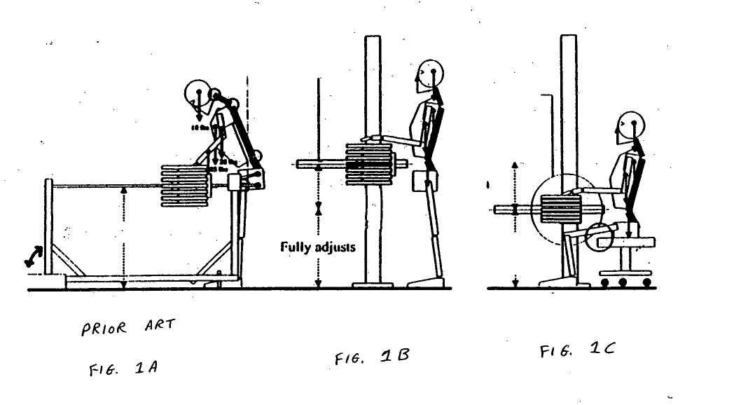

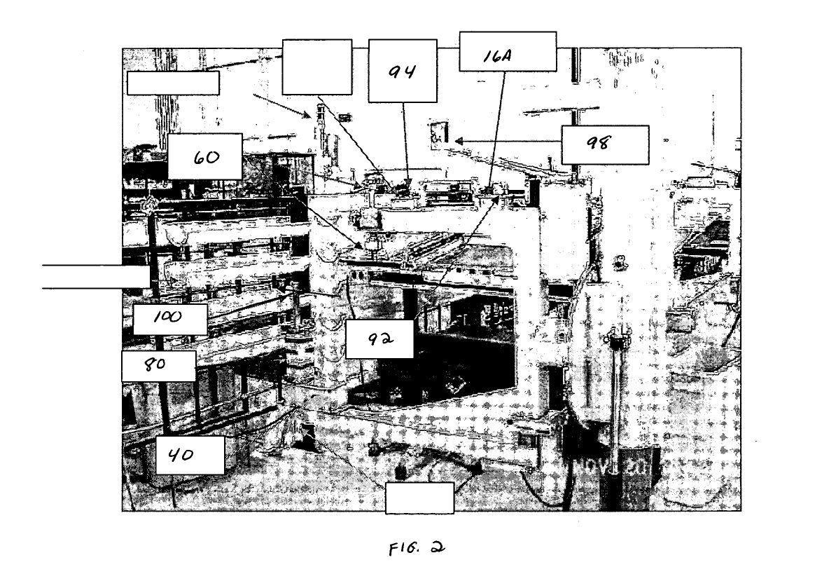

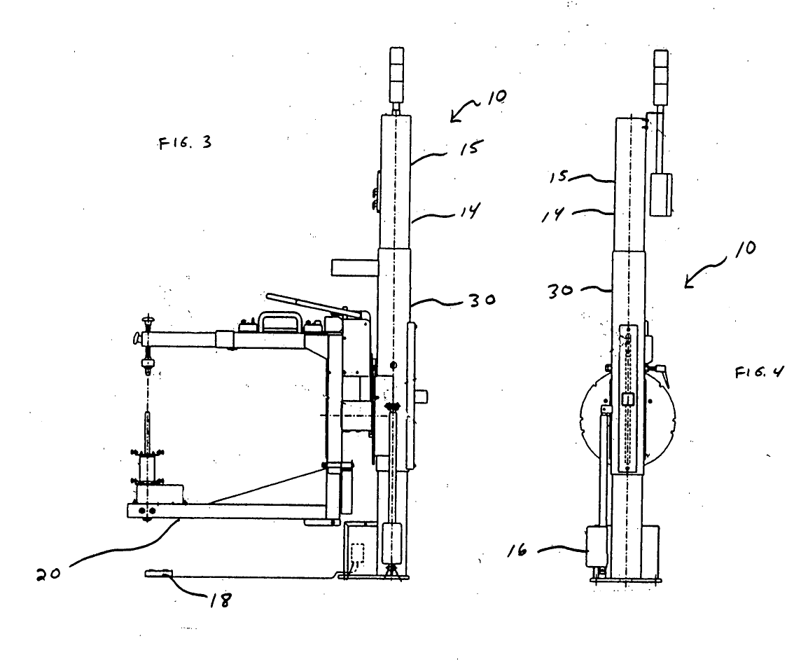

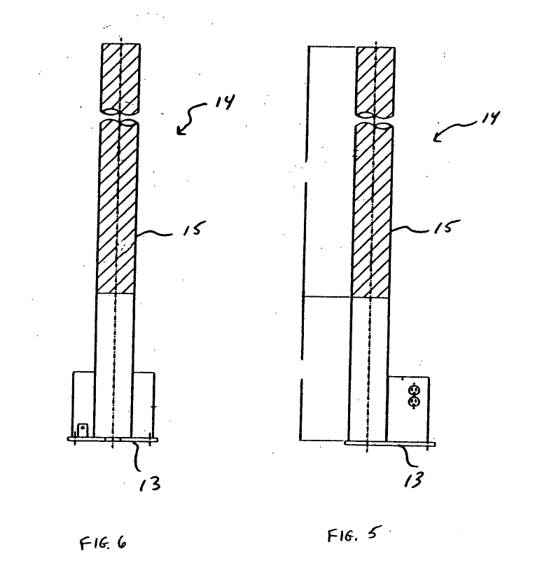

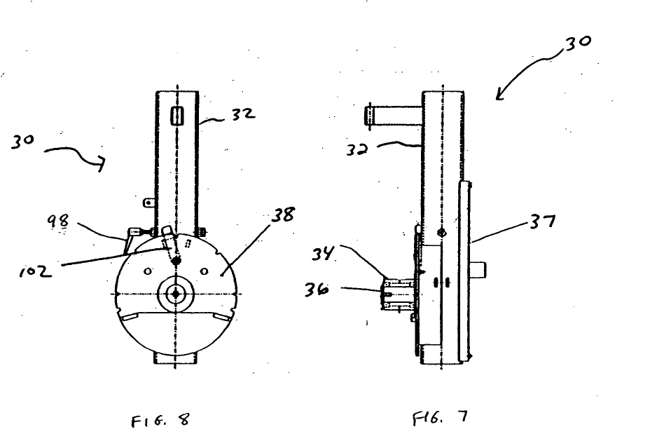

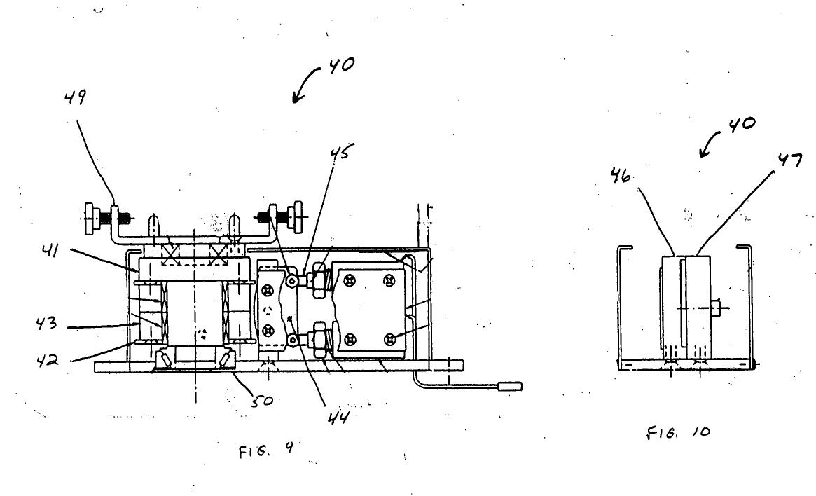

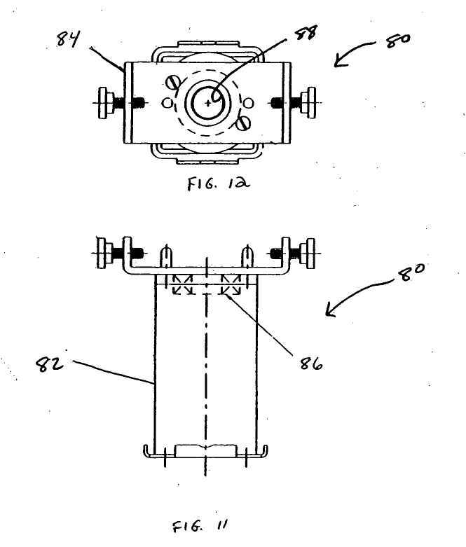

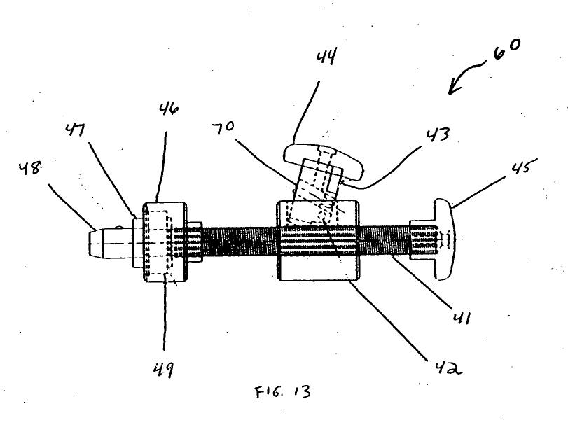

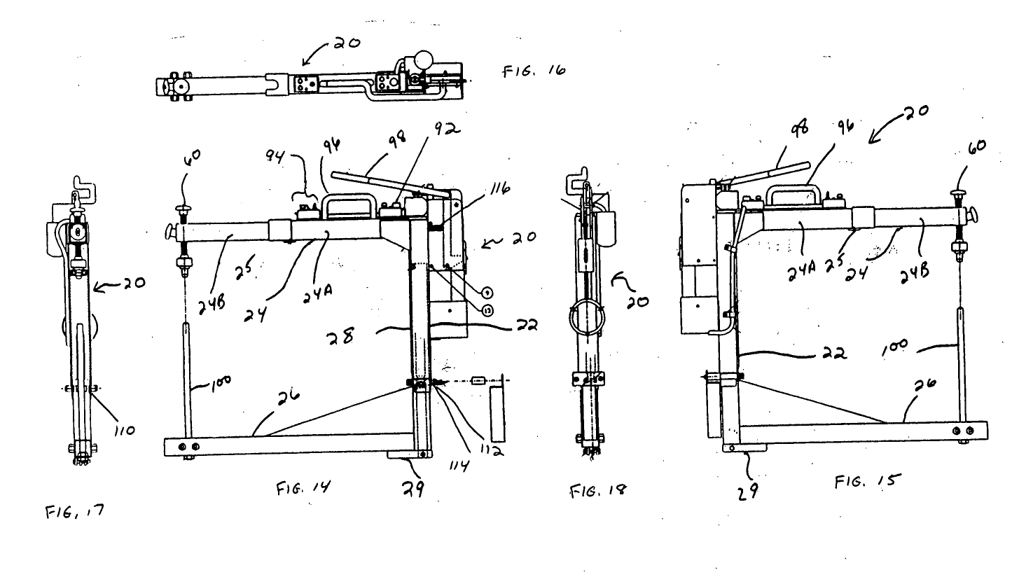

FIG. 1A shows a conventional weaving horse. The horse includes a base and a U-shaped steel frame. A spindle and a clamp extend between opposing outer ends of the frame. A basket form is positioned on the spindle with the clamp holding the basket bottom or splint array in place on the form. The weaving horse suspends the basket form and components assembly at a suitable fixed height and allows rotation of the basket form. Most typically, the rotation of the form on the horse is unrestricted. The free rotation of the form requires a weaver to exert pressure against the form to restrict rotation when desired, which can place the weaver in an awkward position. Some conventional weaving horses have a rudimentary unidirectional ratchet mechanism to limit rotation in a single direction but manual control of the ratchet often is not convenient or efficient.

A corner of the U-shaped frame is pivotally connected to the base such that the form may be flipped from a generally vertical to a generally horizontal position depending on the characteristics and degree of completion of the basket. The position of the horse must be changed manually, which may be tiring, especially when making baskets that require a large, heavy form.

As shown in FIGS. 4 and 5, the weaving horse assembly 10 comprises a base (column assembly) 14 and a clamp arm assembly 30 rotatably secured to the base 14. More particularly, the base 14 may comprise a vertical support member 15 and a carriage assembly 30 slidably mounted on the vertical support member 15, with the clamp arm assembly 20 secured to the carriage assembly 30. Motor drive 16 provides means for moving the carriage assembly 30 relative to the vertical support member 15. A ratchet assembly 40 and an extension assembly 80 are provided on the clamp arm assembly 20. Floor switch 18 actuates the push rod assembly 60 (described below). FIGS. 1B and 1C show a schematic view of the weaving horse of the present invention in positions for standing and seated weaving.

FIG. 6 is a side schematic view and FIG. 7 is a front schematic view of the vertical support member of the weaving horse assembly 10 of FIG. 4. In one embodiment of the invention, the base 14 may take the form of a vertical support member or column 15 attached to a base plate 13. The carriage assembly 30 may take the form of a sleeve 32 having an internal cross section corresponding to the external cross section of the column 15. In the embodiment of the invention shown in FIG. 4, the position of the carriage assembly 30 is infinitely variable within a predetermined vertical range. In other embodiments of the invention (not shown in the drawings), the position of the carriage assembly may be varied at preselected intervals using methods known in the art. The movement of the carriage assembly 30 relative to the vertical support 15 may be power assisted. As shown in FIGS. 4 and 5, a motor drive 16 may be used to move the carriage assembly 30 relative to the vertical support 15, with a motor controller being housed adjacent to the column 15. The carriage assembly 30 also may be moved relative to the vertical support 15 by pneumatic or hydraulic means. A handle may be provided on the carriage assembly 30.

FIG. 8 is a front schematic view and FIG. 9 is a side schematic view of the carriage assembly 30 of the weaving horse assembly of FIG. 4. The carriage assembly includes the carriage or sleeve 32, bearing hub 34, retainer bearing 36, anvil guard 37, and lock disk armor plate 38.

FIG. 10 is a front schematic view and FIG. 11 is a side schematic view of the ratchet assembly 40 of the weaving horse of FIG. 4. The ratchet assembly includes hub 41, gear 42, clamp collar 43, pawl 44, link 45, mounting block 46, plate-solenoid 47, double capture plate 49, and base plate 50. The 3-position ratchet (counter-locking bearing) provides three rotation options. The weaver can select among free rotation in a clockwise direction, free rotation in a counterclockwise direction, and no rotation, by actuating a 3-way switch on the upper arm 24 (shown in FIG. 15). The teeth on the ratchet gear may be spaced finely enough to allow rotation of 1½ degrees per turn or more if desired.

FIG. 12 is a front schematic view and FIG. 13 is a top schematic view of the extension assembly 80 of the weaving horse of FIG. 4. The extension assembly 80 includes extension 82, double capture plate 84, bearing 86, and a central recess 88 for receiving the form pole 100. The extension assembly 80 attaches the basket form to the ratchet assembly 40 and adjusts to the height of the basket form.

FIG. 14 is a side schematic view of the push rod assembly 60 of the weaving horse 10 of FIG. 4. The push rod assembly 60 includes thread rod 61, housing 62, push rod latch 63, push rod latch knob 64, push rod knob 65, bearing block 66, thrust washer 67, shaft 68, bearing 69, and spring plunger 70. The power-assisted push rod assembly 60 allows rapid clamping until close to a desired position and rapid release. A rheostat 92 (shown in FIG. 15) controls the pressure exerted by push rod clamp assembly 60. Preferably, a lower pressure is exerted on the bottoms of smaller baskets and a higher pressure being exerted on the bottoms of larger baskets.

FIG. 15 is a front schematic view, FIG. 16 is a rear schematic view, FIG. 17 is a top schematic view, FIG. 18 is a free end schematic view, and FIG. 19 is a base end schematic view of the clamp arm assembly 20 of FIG. 4. The clamp arm assembly 20 comprises a generally U-shaped frame 22, with the “U” rotated 90 degrees from vertical to define upper 24 and lower 26 arms. The outer bottom 28 of the U-frame may be rotatably mounted to the carriage assembly 30 as shown in FIG. 4. Although the combination of clamp arm rotation and height adjustment offer particular advantages, rotatably mounting the clamp arm assembly to a fixed height support provides benefits not available in the prior art. A counterweight 29 is provided on the bottom 26 of the U-frame 22.

The frame 22 of the clamp arm assembly 20 may be tubular. A frame having a square cross-section yields satisfactory results, although other cross-sectional frame shapes also may be used. The length of the upper arm 24 is slidably adjustable so the push rod assembly 60 can be centered on basket bottoms that vary in size and shape. As shown in FIGS. 15 and 16, this may be accomplished by providing a fixed tubular outer arm 24A that receives a sliding inner arm 24B having a size and shape corresponding to the interior size and shape of the outer arm 24A. A stop, such as screw 25, extends through the outer arm 24A to fix the sliding arm 24B into a desired position.

The free end of the upper arm 24 defines a push rod assembly 60 for clamping a basket bottom to the form. The push rod assembly 60 may extend through the top and bottom of the sliding arm 24B, with a push rod latch 63 and associated knob 64 for releasing the push rod on the outer end face of the sliding arm 24A. A switch for actuating the push rod assembly 60 may be provided on the upper arm 24, on the floor, or in both positions. A rheostat control 92 allows variation of the pressure exerted on the basket bottoms by the push rod clamp, with a lower pressure being exerted on the bottoms of smaller baskets and a higher pressure being exerted on the bottoms of larger baskets.

A switch for operating the clamp arm drive motor 16 (which adjusts the height of the carriage on the support) may be provided on the upper arm 24. The 3-way switch 94 connected to the ratchet assembly 40 for controlling the form rotation also may be provided on the upper arm 24. The clamp arm assembly 20 also may include cam follower 110, needle bearing 112, upper and lower arm roller 114, and spring 116.

A stationary handle 96 may be provided on the upper portion of the outer arm 24A. A release handle 98 is pivotally connected to a notched lever 102, which engages a slot or recess in the lock disk 23. The clamp arm assembly 20 is flipped by urging the release handle 98 toward the stationary handle 96 to disengage the lever 102 from the disk 28 and then rotating the clamp arm assembly 20 to the desired new position.

The free end of the lower arm 26 defines a form pole or spindle 100, which may be received within a spindle-receiving recess provided in the form. The ratchet assembly 40, described above, is supported on the lower arm 26. The form pole 100 extends through the ratchet assembly 40 and the extension assembly 80.

To use the weaving horse assembly in a standing position, a weaver loads the form onto the frame in a vertical position, places a preformed basket bottom on the inverted bottom of the form, and rotates the frame to a horizontal position. The clamp arm assembly supporting the form is raised until the weaver's forearms are at an angle of about 90 degrees relative to the his or her upper arms and his or her back is straight. The clamp arm height should be checked and adjusted if necessary after the form is flipped.

To use the weaving horse assembly in a seated position, the form is positioned between a weaver's legs and close to the weaver's body. The weaver is seated with feet on the floor and the seat height is adjusted until there is no pressure on the undersides of the weaver's legs. The weaver stands to flip the form. A seated weaving position is recommended only for small baskets, and preferably small symmetrical baskets. Weaving of asymmetrical baskets (e.g., oblong baskets) in a seated position may be more difficult and may even require a weaver may rotate his or her body to the side of the form.

The weaving horse assembly is a part of a integrated work station that also includes an adjustable height forming table and material wall. The weaving horse assembly comprises a base and a clamp arm assembly rotatably secured to the base. More particularly, the base may include a vertical support member and a carriage slidably mounted on the vertical support member, with the clamp arm assembly secured to the carriage.

As shown in FIGS. 1B and 1C, the weaving horse assembly of the present invention allows for proper alignment of a weaver's body relative to the horse assembly in both a standing and a seated weaving position compared to the conventional weaving horse of FIG. 1A. The weaving horse assembly allows a weaver to maintain proper alignment of joints, especially back, elbows, arms and hands, and neck; reduces bending, twisting, raising and extension of arms, over flexing of wrists and fingers, and unbalanced stances. It is believed that use of the weaving horse assembly of the present invention will in benefits including more efficient production of high quality baskets, a shorter learning curve for weavers, particularly with respect to shoestring baskets traditionally regarded as being difficult to weave, greater employee satisfaction and comfort, and potentially fewer or less severe injuries resulting from poor body alignment and repetitive motion. The superior quality of basket produced using the weaving horse assembly of the present invention is apparent in that the appearance of certain shoestring baskets constructed using the weaving horse of the present invention varied greatly from those produced on conventional weaving horses because it is so much easier to tightly weave such a basket using the horse of the present invention. The appearance of the shoestring baskets produced on the weaving horse of the present invention varied so much from earlier baskets that it was necessary to modify the basket forms to maintain product consistency.

FIG. 3 shows an embodiment of the forming table of the present invention. The sloped work surface includes a removable clamping unit with adjustable splint stops and a hinged splint clamp slidably mounted on a rod that extends across the rear portion of the clamping unit. The ability to reposition the clamping unit and hinged splint clamp allows left-handed weavers to form basket bottoms more naturally and more efficiently. Like the weaving horse assembly, the height of the forming table is adjustable to accommodate differences in the size of users and individual preferences for forming in a seated or a standing position.

FIG. 2 shows an embodiment of the material storage wall of the present invention. The material wall includes a plurality of open-ended, semi-cylindrical shelves. The shelves hold splints and weave strips of various sizes or colors. The shelves are removably mounted on a rack so they can be repositioned at a height accessible by a user. The shelves include a lip that supports the shelves on the rack or another shelf.

Although a specific embodiment of the present invention has been described in detail, other embodiments are within the scope of this invention. Modifications and variations may be made to the described embodiment by those skilled in the art without departing from the spirit of the invention or the scope of the appended claims. All such modifications and variations are within the scope of the present invention as determined by the appended claims when interpreted in accordance with the benefit to which they are fairly, legally, and equitably entitled.

1. A weaving horse assembly, comprising:
a support structure; and
a clamp arm comprising a U-shaped frame including upper and lower arms each having a free end, the free end of the lower arm defining a form pole for supporting a basket form, the free end of the upper arm defining a clamp for securing a basket bottom to the basket form, and the base of the U-shaped frame being rotatably mounted to the support structure such that the clamp arm is movable from a generally vertical position to a generally horizontal position.

2. The weaving horse assembly of claim 1, wherein the support structure comprises a vertical support member and a carriage slidably mounted on the vertical support member, the base of the U-shaped member being mounted to the carriage, the movement of the carriage relative to the vertical support member adjusting the height of the clamp arm.

3. The weaving horse assembly of claim 1, further comprising means for moving the carriage relative to the vertical support member.

4. The weaving horse assembly of claim 1, further comprising:
a ratchet assembly mounted on the free end of the lower arm, the ratchet assembly cooperating with the form pole such that an operator can select a basket form rotational state from a group consisting of clockwise rotation, counterclockwise rotation, and no rotation.

5. The weaving horse assembly of claim 4, further comprising a switch connected to the ratchet assembly, the switch controlling the basket form rotational state.

6. The weaving horse assembly of claim 1, wherein the upper arm includes a tubular outer arm that terminates at a distance spaced laterally from the form pole and an inner arm slidably receivable within the outer arm, such that the length of the upper arm may be adjusted.

7. The weaving horse assembly of claim 1, wherein the clamp on the free end of the upper arm comprises a push rod assembly.

8. The weaving horse assembly of claim 7, further comprising means for altering the pressure exerted by the push rod assembly against a basket bottom.

9. A weaving horse assembly comprising:
a support structure comprising a vertical support member and a carriage slidably mounted on the vertical support member,
a clamp arm comprising a U-shaped frame including
a base rotatably mounted to the carriage such that the clamp, arm is movable from a generally vertical position to a generally horizontal position;
a lower arm having an end connected to the base and an opposing free end, the free end of the lower arm defining a form pole for supporting a basket form; and
an upper arm having an end connected to the base and an opposing free end, the upper arm including a tubular outer arm that terminates at a distance spaced laterally from the form pole and an inner arm slidably receivable within the outer arm, such that the length of the upper arm may be adjusted,
means for moving the carriage relative to the vertical support member, the movement of the carriage relative to the vertical support member adjusting the height of the clamp arm;
a switch-actuated ratchet assembly mounted on the free end of the lower arm, the ratchet assembly cooperating with the form pole such that an operator can actuate the switch to select a basket form rotational state from the group consisting of clockwise rotation, counterclockwise rotation, and no rotation;
a push rod assembly attached to the free end of the upper arm for securing a basket bottom to the basket form; and
means for altering the pressure exerted by the push rod assembly against a basket bottom.
